(19) United States
(12) Patent Application Publication
(10) Pub. No.: US 2010/0170212 A1
(43) Pub. Date: Jul. 8, 2010

(54) ADJUSTABLE DRIVE AXLE FOR A LAWN MOWER

(76) Inventor: Jörgen Johansson, Jönköping (SE)

Correspondence Address: MOORE & VAN ALLEN PLLC, P.O. BOX 13706, Research Triangle Park, NC, 27709, US

(21) Appl. No.: 12/522,453

(22) PCT Filed: Jan. 12, 2007
(86) PCT No.: PCT/SE07/00015

§ 371 Date: Feb. 18, 2010

(51) Int. Cl. A01D 34/69

(52) U.S. Cl. 56/11.6

(57) ABSTRACT

A self-propelled lawn mower (1) is disclosed, comprising a chassis (2) and at least one drive axle (3) for driving a wheel of the lawn mower (1), wherein the at least one drive axle (3) is displaceably mounted relative to the chassis (2) in a direction perpendicular to a length direction of the at least one drive axle (3).

### TECHNICAL FIELD

The present document relates to self-propelled lawn mowers and methods for assembling and/or adjusting the same. In particular, the present document relates to a lawn mower and a method for assembling and/or adjusting the same according to the appended independent claims.

### BACKGROUND

Conventional walk behind, self-propelled lawn mowers comprise cutting blade, engine, chassis, wheels and handle.

The engine is arranged over the cutting blade at the centre of the chassis to transmit the rotating movement of the engine output shaft directly to the cutting blade which, for security and grass collection reasons, is covered by a protective housing.

The engine power is also used for driving the lawn mower forward. This is accomplished by a transmission arrangement which transfers the rotating movement of the engine output shaft to a pair of drive wheels at the front or rear end of the lawn mower.

The transmission arrangement includes a number of components. A belt pulley unit is arranged between the engine output shaft and a gear box. The gear box is placed in connection to a wheel drive axle which is common to the drive wheel pair and fastened to the chassis. The gear box transfers the rotation of the vertical engine output shaft to a rotation of the horizontal wheel drive axle.

A gear structure is also necessary for reducing the high speed rotation transferred from the engine output shaft into a suitable rotational speed for the wheels. In order to achieve a satisfactory reduction without too bulky or space demanding components in the gear box, the rotational speed reduction is usually carried out in several steps. These may include a greater belt pulley diameter on the drive axle side of the belt transmission arrangement, and/or a toothed gear arrangement between the drive axle and the drive wheels.

U.S. Pat. No. 6,679,036 discloses an example of a drive gear shaft structure of a self-moving type mower, comprising a gearbox sleeved on a drive shaft, the end portions of which are provided with a shaft end gear for engaging a toothed ring on the wheel.

Because the drive transmission in a self-propelled lawn mower makes up a long tolerance train, variations in the individual components and their relative position after assembly have an impact on the overall function of the wheel drive. This makes great demands on the individual tolerances as well as on the manufacturing process as a whole, which increases production costs measured both in money, time and manufacturing complexity.

Drive transmissions are usually arranged with a clutch functionality for adjusting the operational mode of the drive by engaging or disengaging the gearbox. In some lawn mowers the clutch functionality allows a number of drive operational modes ranging from no drive to full drive, i.e. variable speed. This is usually achieved by allowing the user to reduce the belt transmission efficiency by angling the handles forwards, causing the belt pulley on the gearbox side of the belt transmission to be angled forward, and thus the belt to slip and the drive to slow down.

The belt transmission is a particularly vulnerable component, since the belt is prone to stretch over time.

The transmission needs to be adapted for optimal efficiency in full drive operational mode. A slack belt causes the pulleys to spin unintentionally, resulting in a less efficient transmission and malfunction of the wheel drive.

A known way of stretching a slack belt is to angle a belt pulley by tipping the gear box backwards and fastening it in this position. However, by angling one of the belt pulleys, the efficiency of the transmission is reduced, and the belt is exposed to hard wear which risks to damage it. In fact, a majority of reclamations of lawn mowers are caused by problems with the belt transmission. Since tipping the gearbox may not be done repeatedly without causing a cumulative negative effect on the belt drive efficiency, it is not a long term solution for preventing a slack belt.

Other known ways of stretching a slack belt is to use a stretching screw or an extra drive pulley. The use of such additional components however, is costly and adds additional complexity to the lawn mower construction, and to the assembly process thereof.

### SUMMARY

In view of the above, it is an objective to solve or at least reduce the problems discussed above. In particular, an objective is to provide a lawn mower construction which reduces the transmission problems, and allows of a well functioning transmission.

It is an additional objective to accomplish such a lawn mower construction without the need for adding extra components or assembly stages.

It is also an objective to provide a solution which allows of repeated adjustment to compensate for tolerances in the transmission.

The present solution is based on the understanding that by mounting at least one drive axle to the chassis in a displaceable manner a lot of the tolerances in the overall wheel drive transmission can be compensated for.

The present solution is also based on the understanding that at least one drive axle which is fastened to the chassis in a displaceable manner makes it possible to change for example the belt in a transmission and adjust the drive axle position accordingly.

The objectives are wholly or partially achieved by a lawn mower and a method for adjusting the same according to the respective independent claim.

According to a first aspect, a self-propelled lawn mower is provided, comprising a chassis and at least one drive axle for driving a wheel of the lawn mower, wherein the at least one drive axle is displaceably mounted relative to the chassis in a direction perpendicular to a length direction of the at least one drive axle.

By “drive axle” is meant an axle, which purpose is to make a drive wheel rotate. This can be achieved by the drive axle being connected to the wheel directly or indirectly. The drive axle may or may not be a wheel axle.

It should be noted that in the following it is to be understood that the at least one drive axle may be arranged in one or more bearings, such as for example slide bearings or ball bearings, to allow rotation of the drive axle while it is locked to, or in another ways arranged in a certain relation to, other components according to the following descriptions, even when this is not specifically stated.

A lawn mower comprises several components which must be arranged at certain areas of the chassis for good functioning of the lawn mower. The cutter for example, and thus the engine driving it, is arranged essentially at the centre of the chassis, with the wheel pairs symmetrically positioned at the front and end portions of the chassis to provide a stable construction. The at least one drive axle is fastened to the chassis at a suitable position for driving the drive wheels. A displaceably mounted drive axle is advantageous in that it allows of adjustment of the drive axle position to provide an improved interaction between the drive axle and other components. Thus, tolerance trains which the drive axle is part of may be fully or partially compensated for.

The at least one drive axle may be displaceable in a substantially horizontal direction. A horizontally displaceable drive axle is advantageous in that components with which it interacts may have to be positioned at a certain height for good functioning of the lawn mower. The wheels, for example, may need to be arranged at a certain height to provide the lawn mower with good cutting abilities. Moreover, a drive axle is often part of a transmission including for example a belt pulley unit, and as belt pulleys in a unit need to be equally levelled and parallel for the unit to function properly, adjustment of the drive axle is advantageously executed without changing the vertical position thereof.

The at least one drive axle may be displaceable in a drive axle slot of the chassis.

By “drive axle slot” is meant an opening which may or may not have an open end, formed so as to allow displacement of the drive axle, when the drive axle is received therein.

A drive axle slot may readily be provided in the chassis, or deck, of the lawn mower during the manufacturing process. A chassis is often made by form pressing and contour cutting sheet material, and thus a drive axle slot may be formed in the chassis at an existing stage of the manufacturing process.

The at least one drive axle may displaceable along an edge of the chassis.

The self-propelled lawn mower may further comprise a separate mounting element for connecting the at least one drive axle to the chassis.

By “connecting” is meant that the mounting element is arranged so as to provide an area in which the drive axle is displaceable in connection to the chassis, and restrict the movability of the drive axle to this area. Such a mounting element may partly or wholly form a drive axle slot. The chassis and a mounting element may between them form a drive axle slot.

A drive axle guide element may be movably connected to the chassis, for controlling the position of the drive axle relative to the chassis. The drive axle may be fastened in a fixed position relative to the drive axle guide element by suitable methods known in the art. The drive axle may be mounted in a bearing which allows it to rotate, and which is fastened to the drive axle guide element by screwing or welding, or by any other suitable method.

The drive axle guide elements may be arranged for securing other components, for example the handle, to the chassis, enabling an existing lawn mower component to be used for forming the drive axle guide elements. This may allow of a rationalization of the manufacturing process, while a lot of the tolerances in the overall wheel drive transmission can be compensated for in an existing assembling stage, without adding extra components or reducing transmission efficiency.

The drive axle guide element may comprise an opening, in which the drive axle is received.

The self-propelled lawn mower may further comprise a locking mechanism for locking the drive axle in a fixed position relative to the chassis. Such locking mechanisms may include self-tapping screws, bolts with screws, or any other suitable fastening means known in the art.

The locking of the drive axle in a fixed position relative to the chassis may be done directly or indirectly. The drive axle may for example be mounted in a bearing which allows it to rotate, which bearing is directly movably connected to the chassis by locking mechanisms. The locking mechanisms may also be used for movably locking a drive axle guide element, and thus indirectly the drive axle, in a fixed position relative to the chassis.

The self-propelled lawn mower may further comprise at least one locking slot in which the locking mechanism is arranged. Such a locking slot may have an extension in a horizontal direction to allow a movable positioning of the locking mechanism, and thus of the components it directly or indirectly locks to the chassis .

The self-propelled lawn mower may further comprise an engine, arranged on or in the chassis, and a transmission, connecting the drive axle to the engine. The transmission may comprise a belt extending between first and second belt pulleys.

The first belt pulley may be connected to an engine output shaft.

The second belt pulley may be connected to a gear assembly. The gear assembly may comprise a gearbox sleeved on the drive axle.

The gear assembly may be arranged to transmit a movement from the second belt pulley to the drive axle.

Belt pulley units are well known for use in self-propelled lawn mowers. Since the present solution allows of readily adjusting the drive axle to compensate for for example a slack belt in a common transmission without angling the belt pulleys, belt pulley unit, and thus overall drive transmission, efficiency may be improved.

According to a second aspect a lawn mower chassis is provided for providing the lawn mower according to the first aspect, wherein the chassis is adapted for receiving the at least one drive axle such that the at least one drive axle is displaceable in a direction perpendicular to a length direction of the at least one drive axle.

According to a third aspect a method is provided for assembling at least one drive axle in a lawn mower according to the first aspect, comprising mounting the at least one drive axle in a displaceable manner relative to the chassis in a direction perpendicular to a length direction of the at least one drive axle.

The direction may be substantially horizontal.

The position for fastening the drive axle may be chosen by measuring the force exerted on a component in a transmission that the drive axle is part of. For example, if the drive axle is connected directly or indirectly to a belt pulley unit, the force exerted on the belt may be measured while moving the drive axle in a direction in which it is displaceable, so as to find a drive axle position that results in a suitably stretched belt.

According to a forth aspect a method for adjusting a lawn mower according to the first aspect is provided, comprising displacing at least one drive axle relative the chassis in a direction perpendicular to a length direction of the at least one drive axle.

The direction may be substantially horizontal.

The method may comprise loosening a locking mechanism that locks the drive axle in a fixed position relative to the chassis, move the drive axle to a more suitable position, and relocking the locking mechanism. Such a method provides a way of readjusting a drive axle position in order to achieve a more efficient interaction between various components. For example, a slack belt in a transmission train that the drive axle is part of may be stretched out by moving the drive axle, whereby a better drive transmission is achieved, without the need for angling a belt pulley or adding extra components. This provides a way of adapting to, and compensating for, tolerances in a transmission train, making it possible to save money and time on services.

Generally, all terms used in the claims are to be interpreted as claimed in their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present solution will appear from the following detailed disclosure, from the attached dependent claims as well as from the drawing.

### BRIEF DESCRIPTION OF THE DRAWINGS

The above, as well as additional objects, features and advantages of the present solution, will be better understood through the following illustrative and non-limiting detailed description with reference to the appended drawings, where the same reference numerals will be used for similar elements, wherein:

FIG. 1 is a schematic perspective view of a first embodiment of a lawn mower according to the present solution;

FIG. 2 is a schematic sectional side view of a detail of a second embodiment of a lawn mower according to the present solution; and

FIG. 3 is a schematic sectional side view of a detail of a third embodiment of a lawn mower according to the present solution.

### DETAILED DESCRIPTION OF EMBODIMENTS

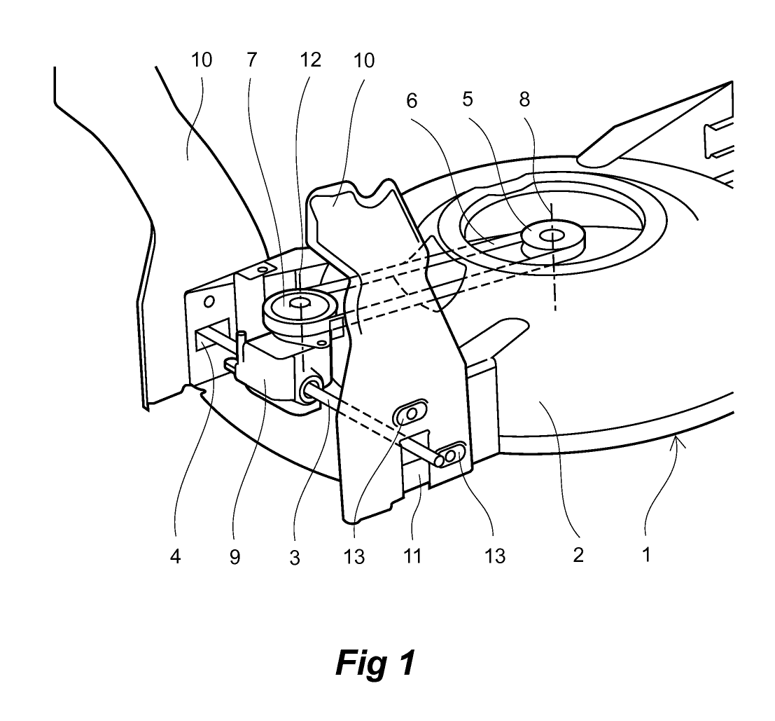

FIG. 1 shows a perspective view of a lawn mower 1 according to the present solution. The lawn mower comprises a chassis 2, an engine (not shown) mounted on the chassis 2, a vertical engine output shaft 8, connected to a cutter (not shown) below the chassis 2 and to a first belt pulley 5. The first belt pulley 5 is via a belt 6 connected to a second belt pulley 7. The second belt pulley 7 is mounted on a vertical shaft 12 extending into a gearbox 9. The gearbox 9 is sleeved on a horizontal drive axle 3 which is drivingly connected to drive wheels (not shown) at both its ends. Each end portion of the drive axle 3 is received in a drive axle slot 4 in the chassis 2, and in an opening 11 of a respective drive axle guide element 10 at each end portion of the drive axle 3.

The drive axle 3 is fastened in a non-displaceable manner to the drive axle guide elements 10, by means of a cylinder shaped shield (not shown). Inside the cylinder shaped shield, a bearing is arranged to enable the drive axle received therein to rotate. The cylinder shaped shields are received in the drive axle slots 4 of the chassis 2, and arranged so as to fill the vertical height, but not the horizontal width, of the drive axle slot 4, to enable horizontal displacement of the cylinder, and thus of the drive axle, in the drive axle slots 4. The drive axle guide elements 10 are formed and arranged so that they can be locked to, and released from, the chassis 2 in a displaceable manner. Thus, the drive axle 3 can be displaced in a horizontal direction along the drive axle slot 4 in the chassis 2 when the drive axle guide elements 10 are released, and the drive axle 3 can be fastened in a fixed position relative to the chassis 2 by locking the drive axle guide elements 10 to the chassis 2.

The drive axle guide elements 10 are locked to the chassis 2 by locking means in the form of self-tapping screws, movably arranged in oblong locking slots 13. The drive axle guide elements 10 may be arranged for securing other components, for example the handle, to the chassis.

During operation of the lawn mower 1, the engine output shaft 8 rotates at high speed to drive the rotating cutter and the first belt pulley 5. The belt 6 transmits the rotation to the second belt pulley 7, and thus to the vertical shaft 12 extending into the gear box 9. The gear box 9 transfers the rotation of the vertical shaft into a slower rotation of the horizontal drive axle 3. The rotation of drive axle 3 is transferred to a pair of (not shown) drive wheels at the respective ends of the drive axle 3, by means of drive axle end gears and toothed rings on the drive wheels.

The transmission thus constitutes a chain of tolerances, including for example the position of the engine, the geometry of the chassis, the diameter of the belt pulleys 5,7, the length and structure of the belt 7 and the components in the gear box 9. The drive axle position is adapted to constitute a compensation for the tolerances in the transmission train to improve transmission efficiency and prolong transmission durability.

By using a method for assembling a lawn mower 1, including mounting a drive axle 3 in a displaceable manner to a chassis 2, the drive axle 3 may be mounted in a position to provide a satisfactory interaction between various components in a transmission. The method may include choosing a position by for example measuring the force exerted on a belt 6, and fastening the drive axle in a position that results in a suitable stretching of the belt 6.

The method provides of a way to compensate for tolerances in the transmission at an existing assembly stage. An advantage is for example that belt pulleys 5,7 can be equally levelled and parallel both from the start and after adjustment of the drive axle position. This reduces the risk of damaged belt pulleys and costly reclamations.

A method for adjustment of a drive axle 3 in a lawn mower 1 according to the present solution may include loosening a locking mechanism, displacing the drive axle 3, and refastening the locking mechanism. The method is useful for example if a belt 6 in the same transmission as the drive axle 3 gets slack over time, or if the belt 6 needs to be changed. By displacing the drive axle 3, variations in new or changed components in the transmission can be compensated for to provide improved transmission efficiency.

The drive axle 3 may drive one or more drive wheels. The drive axle 3 may be connected to the centre of the drive wheels directly, or indirectly by gear arrangements such as for example that described above. The drive axle may be displaceably mounted to the chassis without being received in a slot thereof. For example, the drive axle may be received in a drive axle guide element in the form of for example a clamp or U-bolt, which is movably connected to the chassis by locking means. In such an arrangement the drive axle may be placed in connection to a surface or an edge of the chassis.

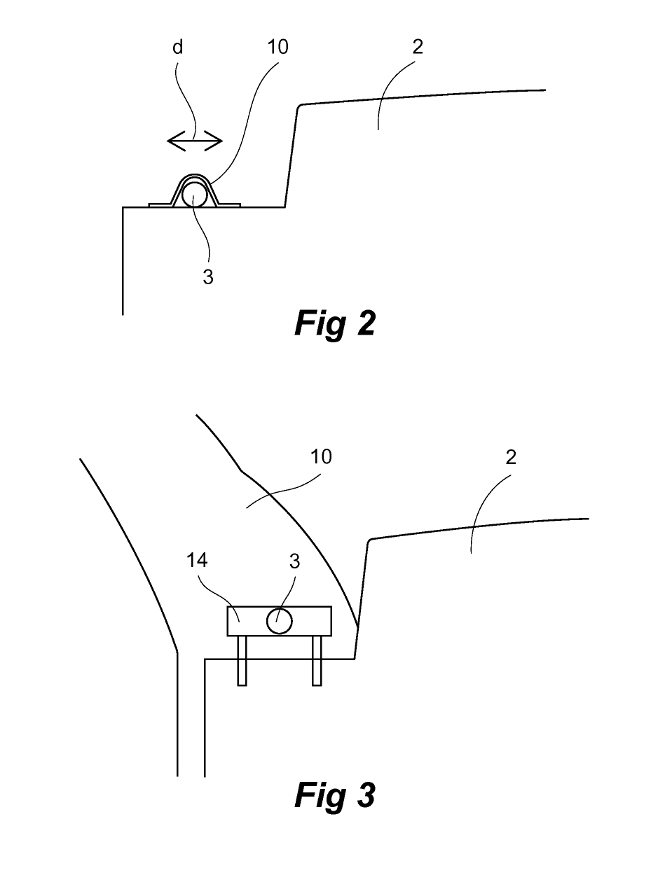

FIG. 2 shows, in a schematic sectional side view, a detail of such an embodiment. A drive axle 3 is mounted to the chassis 2 by means of drive axle guide element 10 in the form of a U-bolt. The axle 2 rests on a flange of the chassis and is held in place by the U-bolt, which is displaceably fastened to the chassis by means of not shown screws inserted through its horizontal portions and oblong locking slots in the flange. The arrangement allows of displacing the drive axle 3 in a direction as indicated by arrow d.

There may be a separate mounting element for connecting the drive axle to the chassis.

The chassis and a separate mounting element may between them define an opening formed so as to allow displacement of a drive axle received therein. The mounting element may be such that it alone defines a drive axle slot, which opening is formed so as to allow displacement of a drive axle received therein.

FIG. 3 shows an example of such an arrangement, where a mounting element 14 is arranged on the chassis 2 to provide a drive axle slot for the mounting of the drive axle 3. A drive axle guide element 10 is also provided for controlling the position of the drive axle 3 in the drive axle slot, according to the same principle as in FIG. 1.

There may be different kinds of drive axle guide elements and/or mounting elements in the same construction.

The drive axle guide elements and/or mounting elements may be connected to different portions of the chassis.

Guide elements and mounting elements are functional designations and it is possible that they are formed as a single part.

There may be more than one drive axle 3 in the same lawn mower construction.

There may be one or more chain gears included in the transmission.

The drive axle 3 may be mounted to the chassis at different stages of the lawn mower assembly process.

The position for fastening the drive axle 3 to the chassis 2 may be chosen by measuring various properties of a transmission train, and components forming part of it.

The solution has mainly been described above with reference to a few embodiments. However, as is readily appreciated by a person skilled in the art, other embodiments than the ones disclosed above are equally possible within the scope of the solution, as defined by the appended patent claims.

What is claimed is:

1. A self-propelled lawn mower comprising:
a chassis; and
at least one drive axle for driving a wheel of the self-propelled lawn mower, wherein the at least one drive axle is displaceably mounted relative to the chassis in a substantially horizontal direction perpendicular to a length direction of the at least one drive axle, and wherein the at least one drive axle is generally linearly displaceable in said substantially horizontal direction.

2. The self-propelled lawn mower as claimed in claim 1, wherein the at least one drive axle is displaceable in a drive axle slot of the chassis.

3. The self-propelled lawn mower as claimed in claim 1, further comprising a separate mounting element for connecting the at least one drive axle to the chassis.

4. The self-propelled lawn mower as claimed in claim 1, further comprising a drive axle guide element that is movably connected to the chassis, for controlling the position of the at least one drive axle relative to the chassis.

5. The self-propelled lawn mower as claimed in claim 4, wherein the drive axle guide element comprises an opening, in which the at least one drive axle is received.

6. The self-propelled lawn mower as claimed in claim 1, further comprising a locking mechanism for locking the at least one drive axle in a fixed position relative to the chassis.

7. The self-propelled lawn mower as claimed in claim 6, further comprising at least one locking slot in which the locking mechanism is arranged.

8. The self-propelled lawn mower as claimed in claim 1, further comprising:
an engine arranged on or in the chassis; and
a transmission connecting the at least one drive axle to the engine.

9. The self-propelled lawn mower as claimed in claim 8, wherein the transmission comprises a belt extending between first and second belt pulleys.

10. The self-propelled lawn mower as claimed in claim 9, wherein the first belt pulley is connected to an engine output shaft.

11. The self-propelled lawn mower as claimed in claim 9, wherein the second belt pulley is connected to a gear assembly.

12. The self-propelled lawn mower as claimed in claim 11, wherein the gear assembly is arranged to transmit a movement from the second belt pulley to the drive axle.

13. A lawn mower chassis for providing the self-propelled lawn mower according to claim 1, wherein the chassis is adapted for receiving the at least one drive axle such that the at least one drive axle is generally linearly displaceable in a substantially horizontal direction perpendicular to a length direction of the at least one drive axle.

14. A method for assembling the self-propelled lawn mower according to claim 1, the method comprising:
mounting the at least one drive axle in a displaceable manner relative to the chassis in a substantially horizontal direction perpendicular to a length direction of the at least one drive axle, and wherein the at least one drive axle is generally linearly displaceable in said substantially horizontal direction.

15. A method for adjusting the lawn mower as defined in claim 1, the method comprising:
displacing the at least one drive axle relative to the chassis in a substantially horizontal direction perpendicular to a length direction of the at least one drive axle, and wherein the at least one drive axle is generally linearly displaceable in said substantially horizontal direction.

16. The self-propelled lawn mower as claimed in claim 1, further comprising a drive axle slot formed in the chassis, the at least one drive axle being displaceable in the drive axle slot.

17. The self-propelled lawn mower as claimed in claim 16, further comprising a drive axle guide element that is movably connected to the chassis for controlling the position of the at least one drive axle relative to the chassis.

18. The self-propelled lawn mower as claimed in claim 17, further comprising a locking mechanism for locking the at least one drive axle in a fixed position relative to the chassis.

19. The self-propelled lawn mower as claimed in claim 18, further comprising a locking slot in which the locking mechanism is arranged.

20. The self-propelled lawn mower as claimed in claim 19, further comprising a separate mounting element for connecting the at least one drive axle to the chassis.
